(19) United States
(12) Patent Application Publication
(10) Pub. No.: US 2021/0053245 A1
(43) Pub. Date: Feb. 25, 2021

(54) HOT KNIFE APPARATUS

(71) Applicant: NOVA TECH INTERNATIONAL, LLC, Graham, NC (US)

(72) Inventor: Mike Flint, Graham, NC (US)

(21) Appl. No.: 16/997,406

(22) Filed: Aug. 19, 2020

Related U.S. Application Data
(60) Provisional application No. 62/888,904, filed on Aug. 19, 2019.

(51) Int. Cl. B26D 1/26; B26F 3/08; B26D 7/20

(52) U.S. Cl. CPC B26D 1/265; B26D 7/204; B26F 3/08

(57) ABSTRACT

A hot knife apparatus for cutting tubular webbing. The hot knife includes an anvil having a surface for cutting a tubular webbing, and a hot knife positioned above the anvil adapted to cut the tubular webbing on the surface of the anvil. The anvil has a first slope on an input side of the apparatus and a second slope on an output side of the apparatus. A pair of spreaders is positioned adjacent to the first slope and the second slope for applying tension to the tubular webbing.

### RELATED APPLICATION

This application claims priority to U.S. Provisional No. 62/888,904, filed Aug. 19, 2019 and herein incorporated by reference in its entirety.

### FIELD OF THE INVENTION

The present invention relates to a hot knife apparatus, and more particularly, to a hot knife apparatus for cutting tubular webbing.

### BACKGROUND

The most common method for cutting webbing involves using a hot knife assembly, typically comprised of a heated knife and an unheated anvil. On cheaper models, the knife and a heater block are constructed in two parts fastened together so that the heater block conducts heat to the knife. The knife-heater assembly is moved mechanically to the anvil where it cuts through the webbing. To prevent the knife from wearing prematurely, the anvil is usually spring loaded so that it will move downward when the knife strikes it. As such, these parts need to be replaced often due to overheating and excessive wear. Furthermore, because the knife itself is both hardened and sharp, it will often cut the webbing instead of melting the webbing. This critical difference is what drives many of the additional functions, such as adjustable dwell timers, speed controls, multiple-cut functions, etc. built into the machinery to melt the unfused fibers that were cut versus melted.

Higher quality models do not use a spring-loaded anvil or a two-piece knife/heater. Instead, these models use a single piece knife/heater design which is much more thermally efficient and relies entirely on the material melting instead of cutting. Knife edges therefore do not need to be hardened, or sharpened, and knives and heaters used in this manner will therefore significantly outlast the other cheaper types that rely on cutting the webbing.

Mechanical movement of the knife/heater is usually accomplished via an electric motor with a chain and sprockets, or a pneumatic cylinder. When tubular webbing is cut on any of these models, regardless of configuration, the webbing is either 1) sealed shut at one or both ends due to thermal fusing, or 2) is cut but not thermally fused.

One of the main drawbacks for current hot knife assemblies is the lack of versality and/or ease of use when dealing with webbing of various sizes, thicknesses and textures. Each type and dimension of webbing requires either separate hot knife units or time-consuming modifications of the hot knife unit for each type of webbing cutting. Moreover, certain components of the hot knife assembly may become deformed or warped with repeated use and therefore require frequent maintenance and repairs.

Thus, there remains a need for apparatuses and processes capable of cutting any variety of tubular webbing while remaining durable and easy to use.

### SUMMARY

To this end, a hot knife apparatus adapted to easily cut a variety of tubular webbing is provided. The hot knife apparatus includes an anvil having a surface for cutting a tubular webbing, and a hot knife positioned above the anvil adapted to cut the tubular webbing on the surface of the anvil. The anvil may include a first slope on an input side of the apparatus and a second slope on an output side of the apparatus. A first and second spreader may be positioned adjacent to the first slope and the second slope, respectively, for applying tension to the tubular webbing.

In one embodiment, the pair of spreaders may be comprised of a first metal sheet adapted to press the tubular webbing onto the first slope and a second metal sheet adapted to press the tubular webbing onto the second slope. The pair of spreaders may further include a serrated edge on each metal sheet for gripping the tubular webbing. An air cylinder may also be included to release the tubular webbing from the serrated edge on one of the metal sheets. In one embodiment, the air cylinder may be positioned near the second metal sheet.

A roller may be included to feed the tubular webbing from the input side onto the anvil. The roller may also be adapted to reverse directions to release the tubular webbing from the pair of spreaders.

In one embodiment, the surface for cutting the tubular webbing is on a top end of the anvil. The surface is preferably substantially flat. The anvil may be adapted to move upward toward the hot knife. For example, a pneumatic cylinder may be attached to the anvil for moving the anvil upward toward the hot knife. The pneumatic cylinder attached to the anvil may be adapted to move the anvil with a greater force than a downward force of the hot knife.

A pneumatic cylinder may be attached to the hot knife for moving the hot knife toward the anvil. The hot knife may have a temperature ranging between about 850° F. and about 950° F. For example, the hot knife may have a temperature of about 900° F.

The hot knife apparatus may also include a dwell timer for pausing movement of the hot knife. The dwell timer may be adjustable such that a duration for pausing movement of the hot knife is user-defined.

Another aspect of the present invention is to provide a hot knife apparatus for cutting tubular webbing comprising an anvil having a surface for cutting a tubular webbing, a first slope on an input side of the apparatus and a second slope on an output side of the apparatus; a roller for feeding the tubular webbing from the input side onto the anvil; a first metal sheet adapted to press the tubular webbing onto the first slope and a second metal sheet adapted to press the tubular webbing onto the second slope, each metal sheet having a serrated edge for gripping the tubular webbing; a hot knife positioned above the anvil adapted to cut the tubular webbing on the surface of the anvil; and an air cylinder for releasing the tubular webbing from the serrated edge on one of the metal sheets. The anvil is adapted to move upward toward the hot knife before or as the hot knife cuts the tubular webbing.

Still another aspect of the present invention is to provide a method of cutting tubular webbing comprising feeding a tubular webbing having a top layer and a bottom layer onto an anvil with a roller, applying tension to a portion of the tubular webbing with a pair of spreaders positioned near a first slope on an input side of the anvil and a second slope on an output side of the anvil, cutting a top layer of the tubular webbing with a hot knife positioned above the anvil, and cutting a bottom layer of the tubular webbing with the hot knife.

These and other aspects of the invention will become apparent to those skilled in the art after a reading of the following description of the embodiments when considered with the drawings.

### BRIEF DESCRIPTIONS OF THE DRAWINGS

FIG. 1 is a perspective view of a hot knife apparatus according to one embodiment;

FIG. 2 is a cross-sectional front view of the hot knife apparatus shown in FIG. 1;

FIG. 3 is an enlarged perspective view of a spreader according to one embodiment;

FIG. 4 is a perspective view of an air ejector positioned at an output end of a hot knife apparatus according to one embodiment; and

FIG. 5 is a perspective view of a roller according to one embodiment.

### DETAILED DESCRIPTION OF THE EMBODIMENTS

The foregoing and other aspects of the present invention will now be described in more detail with respect to the description and methodologies provided herein. It should be appreciated that the invention can be embodied in different forms and should not be construed as limited to the embodiments set forth herein. Rather, these embodiments are provided so that this disclosure will be thorough and complete, and will fully convey the scope of the invention to those skilled in the art.

The terminology used in the description of the invention herein is for the purpose of describing particular embodiments only and is not intended to be limiting of the invention. As used in the description of the embodiments of the invention and the appended claims, the singular forms “a”, “an” and “the” are intended to include the plural forms as well, unless the context clearly indicates otherwise. Also, as used herein, “and/or” refers to and encompasses any and all possible combinations of one or more of the associated listed items.

The term “about,” as used herein when referring to a measurable value such as an amount of a compound, dose, time, temperature, and the like, is meant to encompass variations of 20%, 10%, 5%, 1%, 0.5%, or even 0.1% of the specified amount. Unless otherwise defined, all terms, including technical and scientific terms used in the description, have the same meaning as commonly understood by one of ordinary skill in the art to which this invention belongs.

As used herein, the terms “comprise,” “comprises,” “comprising,” “include,” “includes” and “including” specify the presence of stated features, integers, steps, operations, elements, and/or components, but do not preclude the presence or addition of one or more other features, integers, steps, operations, elements, components, and/or groups thereof.

All patents, patent applications and publications referred to herein are incorporated by reference in their entirety. In case of a conflict in terminology, the present specification is controlling.

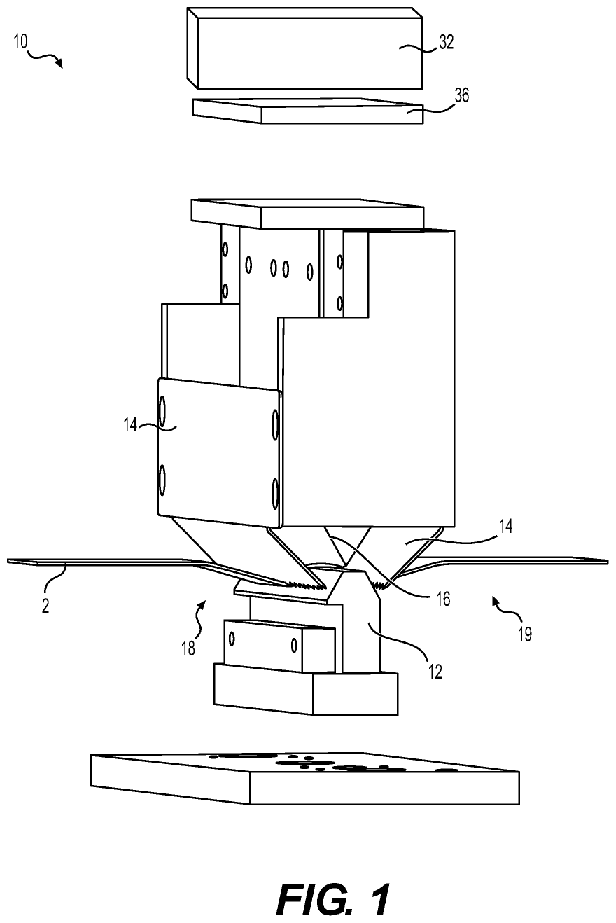

In accordance with the present invention, a hot knife apparatus for cutting tubular webbing is provided. As seen in FIG. 1, the hot knife apparatus 10 comprises an anvil 12 providing a surface for cutting a tubular webbing 2 and a hot knife 16 positioned above the anvil 12 for cutting the tubular webbing 2. A pair of spreaders 14 stretch the tubular webbing 2 over the anvil 2 to apply tension to the webbing.

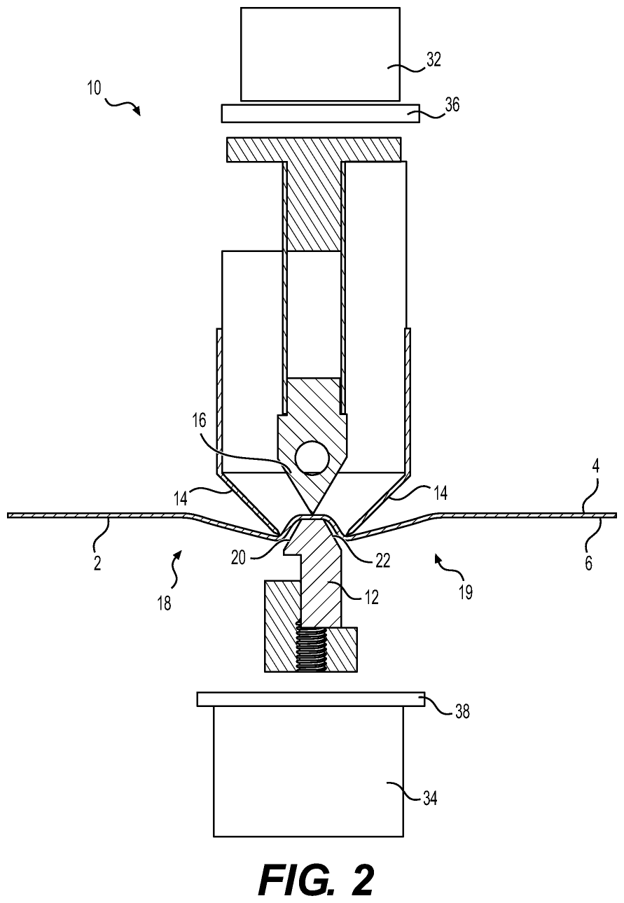

One embodiment of a hot knife apparatus 10 is shown in FIG. 2. A tubular webbing 2 having a top layer 4 and a bottom layer 6 is fed toward an input side 18 onto the anvil 12. A roller 26 may be used to feed the tubular webbing onto the anvil 12. The anvil 12 has a pair of slopes on each side, including a first slope 20 on an input side 18 of the apparatus 10 and a second slope 22 on an output side 19 of the apparatus 10. The pair of slopes on the anvil facilitates cutting of the webbing 2 by enabling a top layer 4 of the webbing 2 to be pulled a greater distance than a bottom layer 6 of the webbing 2. A pair of spreaders 14 holds the webbing 2 to the anvil to provide tension for cutting. Tension is applied to the top layer 4 so that the top layer will be pulled away from the knife when it melts. This prevents it from bonding to the bottom layer 6, which is subsequently cut after the top layer is pulled away.

As seen in FIG. 2, a pneumatic cylinder 32 is attached to the hot knife 16 for moving the hot knife 16 toward the anvil 12 during cutting. A thermal insulator 36 may be included between the hot knife 16 and the pneumatic cylinder 32. The thermal insulator 36 may be comprised of a material such as polytetrafluoroethene or silicon, the selection of which will be within the skill of one in the art.

A heating block (not shown) may be used to heat and regulate the temperature of the hot knife 16. In one example, the heating block may heat the hot knife 16 at a temperature between about 850° F. and about 950° F. For instance, the heating block may heat the hot knife 16 at a temperature of about 900° F. The apparatus 10 may further include a dwell timer (not shown) for determining the duration between each cut. The hot knife 16 may also perform multiple cuts on a single section of a webbing 2. The hot knife 16 may provide a first cut to the top layer 4 and a second cut to the bottom layer 6. The dwell timer may be used to provide a pause between the first and second cuts and enable the hot knife 16 to briefly cool. The duration between each cut may be user-defined with an adjustable dwell timer. For example, the dwell timer may be set to have a pause of about 2 to 5 seconds between each cut.

A pneumatic cylinder 34 may also be attached to the anvil for moving the anvil 12 toward the hot knife 16 during cutting. For example, the pneumatic cylinder 34 may move the anvil 12 upward closer to the hot knife 16, before the pneumatic cylinder 32 moves the hot knife 14 toward the anvil for cutting. The anvil is moved upwards so that the webbing remains substantially horizontal as it is being stretched over the anvil during the cutting process. This prevents the webbing from jamming between cutting cycles. A thermal insulator 38 may also be included between the pneumatic cylinder 35 and the anvil 12.

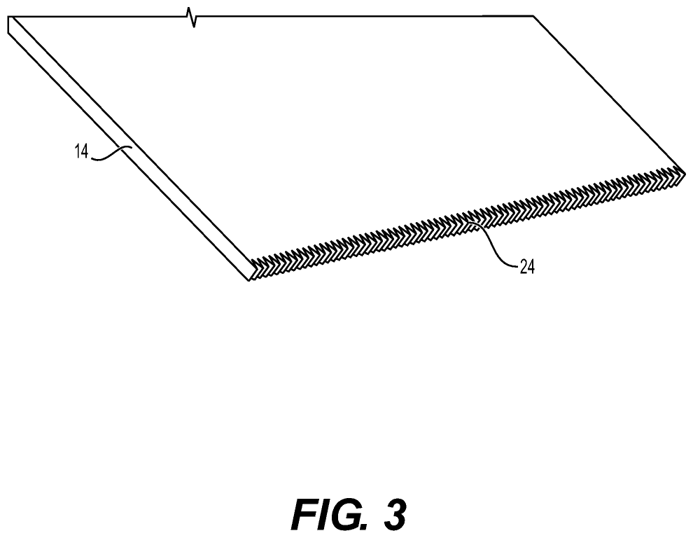

One example of a spreader 14 is shown in FIG. 3. In this example, the spreader is comprised of a metal sheet having a serrated edge for gripping the tubular webbing and providing additional friction to the webbing 2, regardless of the texture of the webbing. In one embodiment, the metal sheet may comprise stainless steel. The serrated edge provides a measure of dynamic tension that automatically accommodates slight misalignments and different thicknesses of webbing. In operation, the serrated edge penetrates and grips the top layer 4, allowing the pair of spreaders to apply tension to the top layer by pulling it in opposing directions. For example, a first spreader located on an input side 18 of the apparatus may penetrate the top layer of the tubular webbing and pull the top layer away from the center of the anvil and toward the input side, and a second spreader located on an output side 19 of the apparatus may penetrate the top layer of the tubular webbing and pull the top layer away from the center of the anvil and toward the output side. In this embodiment, the serrated edge does not penetrate and grip the bottom layer 6, thereby enabling the top layer 4 to pull away as soon as the hot knife 16 melts through it so that the top layer 4 will not adhere to the bottom layer 6.

Embodiments of the serrated edge may vary by the number of serrations and the tips employed at each serration. For example, the tips may be pointed or rounded. The spaces, namely gullies, between each serration may also vary, wherein some embodiments may employ shallow gullies and other embodiments may employ deep gullies. In certain embodiments, the edge may include a combination of smooth and serrated portions.

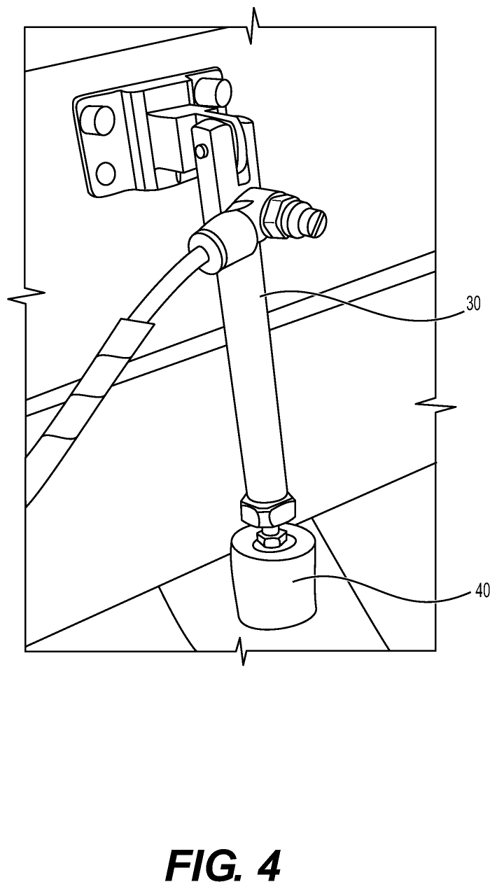

FIG. 4 depicts an air ejector 30 for removing a tubular webbing from the serrated edge of a spreader 14. The air ejector 30 may be comprised of a simple air cylinder with a rubber bumper 40 at the end to pull the webbing from the cutting machine. In one embodiment, an air ejector 30 is placed on an output side of the apparatus 10. After the hot knife 16 cuts the tubular webbing 2, the webbing 2 may be removed from the spreader 14 by using pressurized air from the air ejector 30.

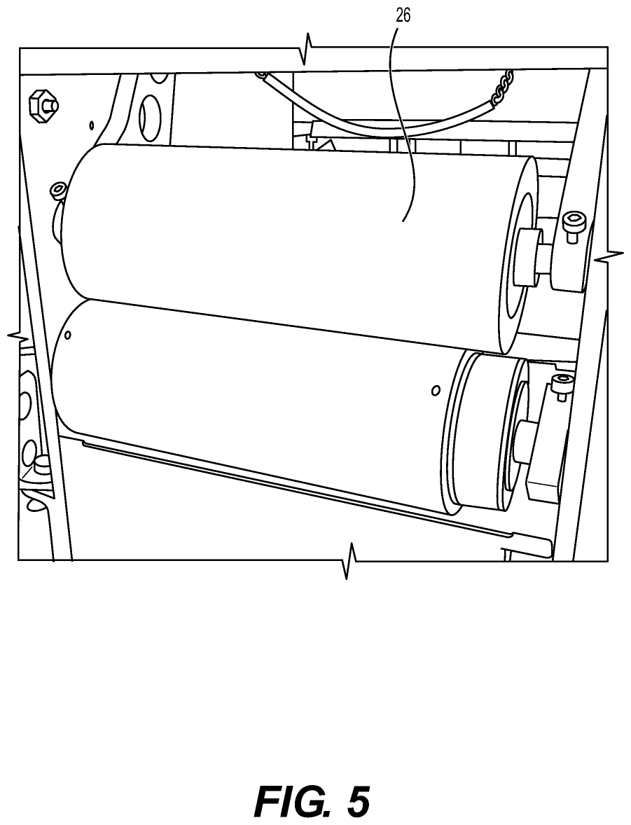

The roller 26 may also be used to remove the tubular webbing from the spreader 14. One example of a roller 26 is shown in FIG. 5. For instance, the roller 26 may turn in a reverse direction to pull the webbing 2 from the serrated edge of a spreader. In one preferred embodiment, the hot knife apparatus 10 uses a roller 26 to remove the webbing from a spreader near an input side of the apparatus and an air ejector 30 to remove the webbing from the spreader near an output side of the apparatus.

The present invention may also be considered a method for cutting tubular webbing. In one embodiment, the method comprises feeding a tubular webbing having a top layer and a bottom layer onto an anvil with a roller, applying tension to a portion of the tubular webbing with a pair of spreaders positioned near a first slope on an input side of the anvil and a second slope on an output side of the anvil, cutting a top layer of the tubular webbing with a hot knife positioned above the anvil, and cutting a bottom layer of the tubular webbing with the hot knife. The anvil may be moved closer toward the hot knife 16 before each cut using a pneumatic cylinder. In one embodiment, tension may be applied by pulling a top layer of the webbing a greater distance than a bottom layer of the webbing. For example, the pair of spreaders may each have a serrated edge, and tension may be applied to the tubular webbing by gripping the top layer of the webbing with each serrated edge. A first spreader on the input side pulls the top layer down the first slope and the second spreader on the output side pulls the top layer down the second slope. The webbing may be removed from the serrated edge by rotating the roller in a reverse direction and/or applying a pneumatically actuated extraction pusher with an air cylinder.

Although the present approach has been illustrated and described herein with reference to preferred embodiments and specific examples thereof, it will be readily apparent to those of ordinary skill in the art that other embodiments and examples may perform similar functions and/or achieve like results. For example, the hot knife apparatus may also be adapted for use in a manual process whereby the user inserts the webbing through the apparatus to a desired length and then initiates the timed cutting process (e.g., stepping on a foot pedal). The user then manually pulls the webbing out from the tooling after cutting. All such equivalent embodiments and examples are within the spirit and scope of the present approach.

That which is claimed is:

1. An automatic hot knife apparatus for cutting tubular webbing comprising:
(a) an anvil having a surface for cutting a tubular webbing, a first slope on an input side of the apparatus and a second slope on an output side of the apparatus;
(b) a pair of spreaders positioned adjacent to the first slope and the second slope adapted to grip the tubular webbing and apply tension to a top layer of the tubular webbing; and
(c) a hot knife positioned above the anvil adapted to cut the tubular webbing on the surface of the anvil.

2. The automatic hot knife apparatus of claim 1, wherein the pair of spreaders is comprised of a first metal sheet adapted to press the tubular webbing onto the first slope and a second metal sheet adapted to press the tubular webbing onto the second slope.

3. The automatic hot knife apparatus of claim 2 further including a serrated edge on each metal sheet for gripping the top layer of the tubular webbing.

4. The automatic hot knife apparatus of claim 4 further including an air cylinder for releasing the tubular webbing from the serrated edge on one of the metal sheets.

5. The automatic hot knife apparatus of claim 5, wherein the air cylinder is positioned near the second metal sheet.

6. The automatic hot knife apparatus of claim 1 further including a roller for feeding the tubular webbing to a preset length from the input side onto the anvil.

7. The automatic hot knife apparatus of claim 6, wherein the roller is adapted to reverse directions to release the tubular webbing from the pair of spreaders.

8. The automatic hot knife apparatus of claim 1, wherein the surface for cutting the tubular webbing is on a top end of the anvil.

9. The automatic hot knife apparatus of claim 8, wherein the surface is substantially flat.

10. The automatic hot knife apparatus of claim 1, wherein the anvil is adapted to move upward toward the hot knife.

11. The automatic hot knife apparatus of claim 10 further including a pneumatic cylinder attached to the anvil for moving the anvil upward toward the hot knife.

12. The automatic hot knife apparatus of claim 11, wherein the pneumatic cylinder attached to the anvil is adapted to move the anvil with a greater force than a downward force of the hot knife.

13. The automatic hot knife apparatus of claim 1 further including a pneumatic cylinder attached to the hot knife for moving the hot knife toward the anvil.

14. The automatic hot knife apparatus of claim 1, wherein the hot knife has a temperature between about 850° F. and about 950° F.

15. The automatic hot knife apparatus of claim 1, wherein the hot knife has a temperature of about 900° F.

16. The automatic hot knife apparatus of claim 1 further including a dwell timer for pausing movement of the hot knife.

17. The automatic hot knife apparatus of claim 16, wherein the dwell timer is adjustable whereby a duration for pausing movement of the hot knife is user-defined.

18. An automatic hot knife apparatus for cutting tubular webbing comprising:
(a) an anvil having a surface for cutting a tubular webbing, a first slope on an input side of the apparatus and a second slope on an output side of the apparatus;
(b) a roller for feeding the tubular webbing from the input side onto the anvil;
(c) a first metal sheet adapted to press the tubular webbing onto the first slope and a second metal sheet adapted to press the tubular webbing onto the second slope, each metal sheet having a serrated edge for gripping a top layer of the tubular webbing;
(d) a hot knife positioned above the anvil adapted to cut the tubular webbing on the surface of the anvil; and
(e) an air cylinder for releasing the tubular webbing from the serrated edge on one of the metal sheets,
wherein the anvil is adapted to move upward toward the hot knife as the hot knife cuts the tubular webbing.

19. A method of cutting tubular webbing comprising:
feeding a tubular webbing having a top layer and a bottom layer onto an anvil with a roller;
applying tension to a portion of the tubular webbing with a pair of spreaders positioned near a first slope on an input side of the anvil and a second slope on an output side of the anvil;
cutting a top layer of the tubular webbing with a hot knife positioned above the anvil; and
cutting a bottom layer of the tubular webbing with the hot knife.

20. The method of claim 19 further including moving the anvil up, then cutting the top layer of the tubular webbing.

21. The method of claim 19 further including moving the anvil up, then cutting the bottom layer of the tubular webbing.

22. The method of claim 20, wherein applying tension on the portion of the tubular webbing to be cut comprises pulling the top layer of the tubular webbing a greater distance than the bottom layer of the tubular webbing.

23. The method of claim 22, wherein applying tension on the portion of the tubular webbing comprises applying tension on an output side of the tubular webbing using a first spreader and applying tension on an input side of the tubular webbing using a second spreader.

24. The method of claim 23, wherein applying tension on the input and output sides comprises gripping the top layer using a serrated edge on each spreader.

25. The method of claim 24 further including removing the tubular webbing from the first spreader by rotating the roller in a reverse direction.

26. The method of claim 24 further including removing the tubular webbing from the second spreader by applying a pneumatically actuated extraction pusher with an air cylinder.
